(19) United States
(12) Patent Application Publication
(10) Pub. No.: US 2007/0121237 A1
(43) Pub. Date: May 31, 2007

(54) Read circuit and hard disk drive using the same

(75) Inventors: Hiroyasu Yoshizawa, Ome (JP); Yoichiro Kobayashi, Ome (JP); Toshio Shinomiya, Ome (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/604,849

(22) Filed: Nov. 28, 2006

(30) Foreign Application Priority Data
Nov. 30, 2005 (JP) 2005-344879

(51) Int. Cl. G11B 5/03

(52) U.S. Cl. 360/66

(57) ABSTRACT

A magnetic disk apparatus-purpose reproducing circuit capable of performing a high speed and under stable condition. In the magnetic disk apparatus-purpose reproducing circuit equipped with: a bias circuit for applying a bias voltage with respect to an MR (Magneto-Resistive) head, an amplification circuit for amplifying an output of the MR head, capacitors C0 and C1 for cutting a DC component contained in the output of the MR head, and a conductor amplifier for applying an input bias of the amplifier, a shortcircuit-purpose switch S0 for charging the DC cut capacitors are further provided. When a mode transition from a write mode to a read mode occurs, the shortcircuit-purpose switch S0 is turned ON so as to charge the DC cut capacitors, so that a mode transition characteristic capable of establishing a high speed characteristic and a stable characteristic can be obtained.

### INCORPORATION BY REFERENCE

The present application claims priority from Japanese application JP2005-344879 filed on Nov. 30, 2005, the content of which is hereby incorporated by reference into this application.

### BACKGROUND OF THE INVENTION

The present invention generally relates to a reproducing circuit for reproducing information recorded on a recording medium. More specifically, the present invention is directed to such a reproducing circuit suitable for a magnetic disk apparatus which reads out information from a magnetic recording medium by employing a magneto-resistive head (will be referred to as “MR head” hereinafter), and also directed to a magnetic disk apparatus employing the reproducing circuit.

### DESCRIPTION OF THE RELATED ART

JP-A-2003-152472 describes a voltage/current converting ratio switching circuit used to charge a DC cut capacitor in a reproducing circuit of a magnetic disk apparatus-purpose preamplifier. As shown in FIG. 3 of this patent publication, settling of readout outputs of the preamplifier is carried out in a high speed by temporarily changing a voltage/current converting ratio of a conductor connected to an input of an amplifier when an operation mode is switched from a write mode to a read mode.

A preamplifier employed in a magnetic disk apparatus owns a plurality of operation modes such as a write mode for writing data into a recording medium, a read mode for reading data from the recording medium, and a sleep mode for stopping operation thereof. In conjunction with increases of recording density of recording media and increases of transfer speeds thereof, times required for transferring the respective operation modes to each other are also required to be shortened. In particular, there is a strong demand for shortening transition times between a write mode and a read mode. Presently, the required transition times from write modes to read modes (namely, times up to read output setting) are several tens of nanoseconds to several hundreds of nanoseconds.

FIG. 9 indicates a block arrangement of a general-purpose reproducing circuit of a differential preamplifier used for a magnetic disk apparatus. The reproducing circuit is arranged by containing a bias circuit 200, an amplifier 300, DC cut capacitors C0 and C1, and a conductor amplifier 400. The bias circuit 200 applies a bias voltage (VMR) to an MR head 100. The amplifier 300 amplifies an output from the MR head 100. The DC cut capacitors C0 and C1 cut a DC component of the output of the MR head 100. The conductor amplifier 400 is utilized for charging and discharging operations of the DC cut capacitors, and for applying an input bias of the amplifier 300. In this drawing, symbol “Vmp” shows an MR head-sided positive polarity terminal; symbol “Vmn” indicates an MR head-sided negative polarity terminal; symbol “Vip” represents a differential input positive polarity terminal; symbol “Vin” denotes a differential input negative terminal; symbol “Vop” shows a differential output positive polarity terminal; symbol “Von” represents a differential output negative polarity terminal; and symbol “VMR” indicates an MR head bias voltage.

During a read time period, electric charges corresponding to the bias voltage VMR of the MR head 100 are charged to the DC cut capacitors C0 and C1, whereas during a write time period, since both switches S3 and S4 are turned ON, both terminals of the MR head 100 are shortcircuited to the ground. As a result, the electric charges of the DC cut capacitors C0 and C1 are brought into discharged states. Presently, while a transition time from a write mode to a read mode is mainly restricted to a charging time of the DC cut capacitors C0 and C1, it is so important to realize highspeed of a charging time.

Prior to the present patent application, Inventors of the present invention considered technical ideas capable of shortening mode transition times by switching an amplification factor of the conductor amplifier 400. JP-A-2003-152472 indicates such a technical idea that the amplification factor of the conductor amplifier 400 is temporarily increased in a mode transition. FIG. 10 represents control signals and potential responses of input/output terminals during a mode transition from a write mode to a read mode in the case that the above-explained mode transition time shortening method is employed. When a mode transition from a write mode to a read mode occurs, the switches S1 and S2 connected to the MR head 100 are turned ON, and the switches S3 and S4 connected to the MR head 100 are turned OFF. Also, during a predetermined time period after the mode transition is commenced, switches S7 and S8 are turned ON which increase the amplification factor of the conductor amplifier 400. At this time, the switches S5 and S6 are turned OFF. Since the bias circuit 200 is connected via the switches S1 and S2 to the MR head 100, the bias voltage VMR is applied between the MR head-sided positive polarity terminal Vmp and the MR head-sided negative polarity terminal Vmn. At this time, a rising response of the terminal potential of the MR head 100 is a high speed, and a potential difference equivalent to the bias voltage VMR is also generated between the terminals Vip and Vin of the differential input terminals based upon a relationship for holding the electric charges.

The charging operation is carried out with respect to the DC cut capacitors C0 and C1 in the negative feedback operation in such a manner that the potential difference between the differential input terminals Vip and Vin of the amplifier 300 becomes zero. Under such a normal read condition that the switches S5 and 6 are turned ON and the switches S7 and S8 are turned OFF, the amplification factor of the conductor amplifier 400 has been relatively set to a low value “gm0” in order to reduce noise. In such a predetermined time period of the read mode during which the switches S5 and S6 are turned OFF and the switches S7 and S8 are turned ON, the amplification factor is increased to be a relatively high value “gm1”, so that the response of the negative feedback operation becomes a high speed. That is, the charging operation of the DC cut capacitors C0 and C1 is performed in the high speed.

However, since the negative feedback loop including the conductor amplifier 400 own second order, or more order of response characteristics which contain an internal pole of the conductor amplifier 400, the amplification gain is excessively increased in the arrangement shown in FIG. 9. As a consequence, there is such a problem that the stable characteristic of the feedback loop is possibly deteriorated. The mode transition times from several tens of nanoseconds to several hundreds of nanoseconds, which are presently required, constitute such a level which can hardly set the gain during the transition time period, and also, can hardly secure the stability of the negative feedback loop.

### SUMMARY OF THE INVENTION

An object of the present invention is to provide a magnetic disk apparatus-purpose reproducing circuit capable of realizing a mode transition from a write mode to a read mode in a high speed under stable condition.

One example of typical exemplifications according to the present invention will now be described as follows: That is, a reproducing circuit, according to an aspect of the present invention, is featured by comprising: a first bias circuit connected to differential output terminals of a magneto-resistive head for generating a differential output voltage corresponding to information read out from a magnetic recording medium between the differential output terminals, for applying a bias voltage between a positive polarity and a negative polarity of the differential output terminals;

one pair of DC cut capacitors connected to the differential output terminals of the magneto-resistive head, for cutting off a DC component of an output of the magneto-resistive head; an output amplifier which has differential input terminals constructed of a positive polarity and a negative polarity, is connected via the one pair of DC cut capacitors to the differential output terminals of the magneto-resistive head by way of the differential input terminals, and amplifies the output of the magneto-resistive head, the DC component of which has been cut off; a conductor amplifier which has differential input terminals and differential output terminals, which are constituted by positive polarities and negative polarities, and is connected to the differential input terminals of the output amplifier in a negative feedback manner so as to apply an input bias of the output amplifier; and a shortcircuit switch connected between the positive polarity and the negative polarity of the differential input terminals of the output amplifier.

Also, a magnetic disk apparatus, according to another aspect of the present invention, is featured by such a magnetic disk apparatus operated in operation modes including a read mode and a write mode, and arranged by comprising: a magneto-resistive head having differential output terminals constructed of a positive polarity and a negative polarity, and generating a differential output voltage corresponding to information read out from a magnetic recording medium during the read mode at this differential output terminal; and a reproducing circuit for amplifying the differential output voltage outputted to the differential output terminals by the magneto-resistive head to output the amplified differential output voltage to a signal processing circuit; in which: the reproducing circuit is comprised of: a first bias circuit connected to the differential output terminals of the magneto-resistive head, for applying a bias voltage between the positive polarity and the negative polarity of the differential output terminals; one pair of DC cut capacitors connected to the differential output terminals of the magneto-resistive head, for cutting off a DC component of an output of the magneto-resistive head; an output amplifier which has differential input terminals constructed of a positive polarity and a negative polarity, is connected via the one pair of DC cut capacitors to the differential output terminals of the magneto-resistive head by way of the differential input terminals, and amplifies the output of the magneto-resistive head, the DC component of which has been cut off; a conductor amplifier which has differential input terminals and differential output terminals, which are constituted by positive polarities and negative polarities, and is connected to the differential input terminals of the output amplifier in a negative feedback manner so as to apply an input bias of the output amplifier; and a shortcircuit switch for shortcircuiting a path between the positive polarity and the negative polarity of the differential input terminals of the output amplifier based upon a transition of the operation modes; and in which: an amplification factor of the conductor amplifier is substantially constant irrespective of such a fact that the operation mode of the magnetic disk apparatus corresponds to either the read mode or the write mode.

In accordance with the present invention, in the reproducing circuit used for the magnetic disk apparatus, there is such an advantage that the mode transition from the write mode to the read mode can be carried out in a high speed.

### BRIEF DESCRIPTION OF THE DRAWINGS

FIG. 1 is a structural diagram for showing a first embodiment of a reproducing circuit to which the present invention is applied.

FIG. 2 is an input/output timing chart for representing a mode transition as to the first embodiment of the reproducing circuit to which the present invention is applied.

FIG. 3 is a structural diagram for indicating a second embodiment of a reproducing apparatus according to the present invention, which is arranged by that a dual-structured amplifier is applied as the amplifier employed in the reproducing circuit of FIG. 1.

FIG. 4 is an input/output timing chart for representing a mode transition as to the second embodiment of a reproducing circuit to which the present invention is applied.

FIG. 5 is a structural diagram of a third embodiment of a reproducing circuit according to the present invention, which is arranged by that a mechanism for holding electric charges of a DC cut capacitor is further employed in the reproducing circuit of FIG. 1.

FIG. 6 is an input/output timing chart for representing a mode transition as to the third embodiment of a reproducing circuit to which the present invention is applied.

FIG. 7 is a structural diagram for indicating a fourth embodiment of a reproducing apparatus according to the present invention, which is arranged by that a dual-structured amplifier is applied as the amplifier employed in the reproducing circuit of FIG. 5.

FIG. 8 is an input/output timing chart for representing a mode transition as to the fourth embodiment of the reproducing circuit to which the present invention is applied.

FIG. 9 is a block structural diagram for showing a general-purpose reproducing circuit of a magnetic disk apparatus-purpose differential preamplifier.

FIG. 10 is the input/output timing chart for representing the mode transition as to the reproducing circuit shown in FIG. 9.

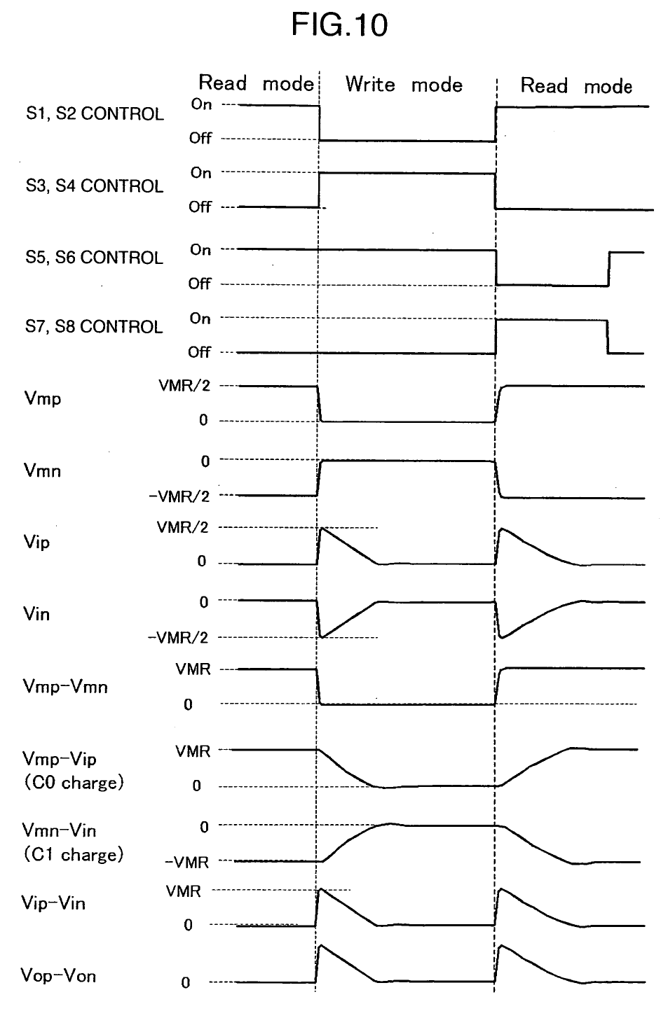

FIG. 11 is a block diagram for representing an example of a magnetic disk apparatus (hard disk apparatus) as one example of a useful medium recording/reproducing system with employment of a reproducing circuit to which the present invention is applied.

### DETAILED DESCRIPTION OF THE EMBODIMENTS

Referring now to drawings, various embodiments of the present invention will be described in detail. It should be understood that although circuit elements except for an MR (Magneto-Resistive) head, which constitute respective blocks of embodiments, are not especially restricted, these circuit elements are manufactured in such a manner that these circuit elements are integrated on a single semiconductor substrate made of, for example, monocrystal silicon in one chip by using known integrated circuit techniques for bipolar transistors, CMOS (complementary type MOS) transistors, and the like. It should also be noted that reference numerals and symbols which are commonly indicated in the respective drawings represent meanings which are commonly used in the respective drawings.

### Embodiment 1

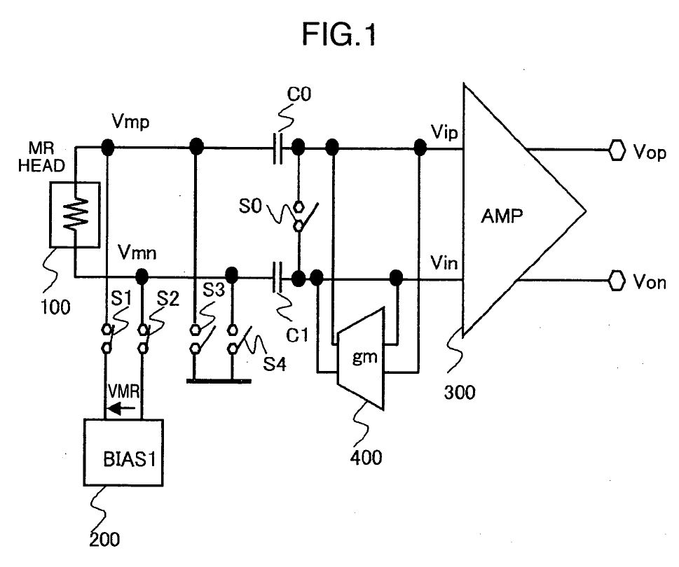

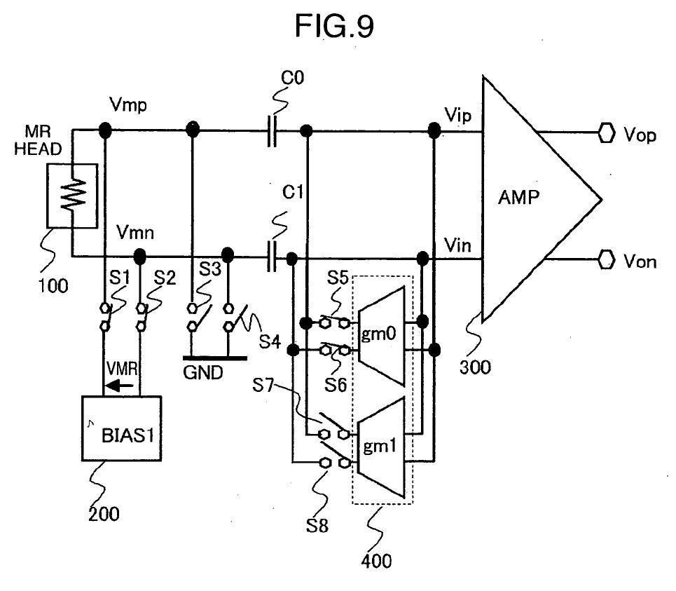

FIG. 1 shows a first embodiment of a magnetic disk apparatus-purpose reproducing circuit to which the present invention is applied. The above-described reproducing circuit is arranged by containing a bias circuit 200, an amplifier 300, DC cut capacitors C0 and C1, a conductor amplifier 400, a shortcircuit-purpose switch S0, and various sorts of selecting switches S1 to S4. The bias circuit 200 applies a bias voltage (VMR) to an MR (Magneto-Resistive) head 100. The amplifier 300 amplifies an output from the MR head 100. The DC cut capacitors C0 and C1 cut a DC component of the output of the MR head 100. The conductor amplifier 400 is utilized for applying an input bias of the amplifier 300. The shortcircuit-purpose switch S0 is employed so as to charge the DC cut capacitors C0 and C1. This arrangement of the reproducing circuit of the first embodiment owns the below-mentioned different points from the arrangement of FIG. 9. That is, although the above-explained switches S5 to S8 are not provided, the shortcircuit-purpose switch S0 is provided, and an amplification factor of the conductor amplifier 400 has been set to a predetermined single amplification factor “gm” in the reproducing circuit of the first embodiment. In this drawing, symbol “Vmp” shows an MR head-sided positive polarity terminal; symbol “Vmn” indicates an MR head-sided negative polarity terminal; symbol “Vip” represents a differential input positive polarity terminal; symbol “Vin” denotes a differential input negative terminal; symbol Vop” shows a differential output positive polarity terminal; symbol “Von” represents a differential output negative polarity terminal; and symbol “VMR” indicates an MR head bias voltage.

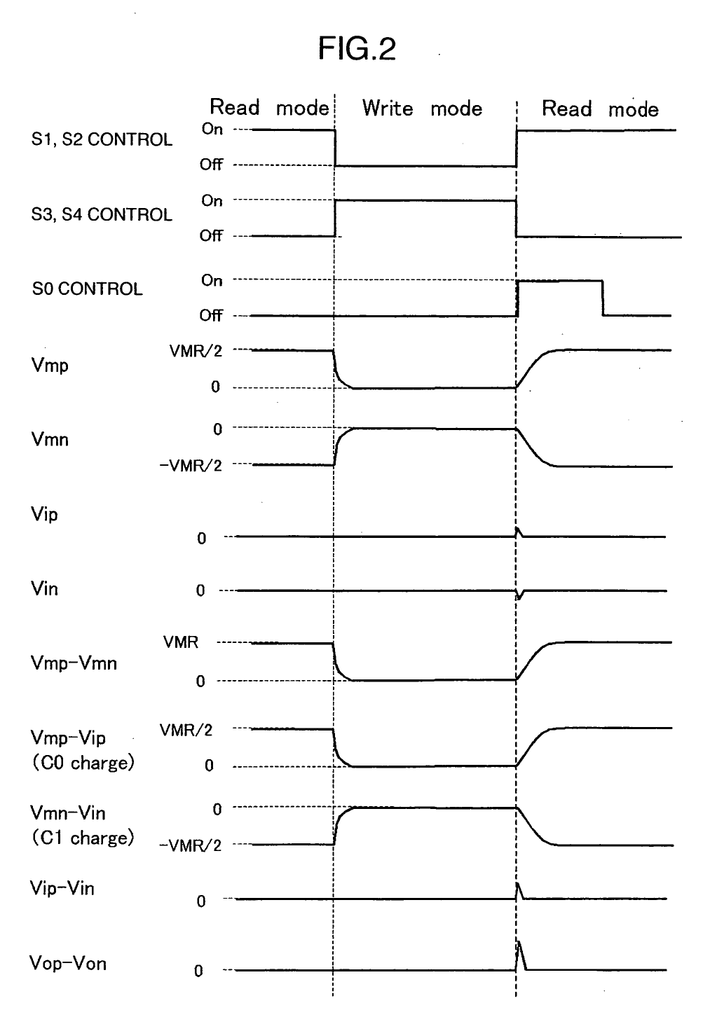

FIG. 2 represents potential responses as to control signals and input/output terminals when a mode transition from a write mode to a read mode occurs. As represented in FIG. 2, when a mode transition from a write mode to a read mode occurs, the switches S1 and S2 which are connected to the MR head 100 are turned ON, whereas the switches S3 and S4 which are connected to the MR head 100 are turned OFF, and also, the shortcircuit-purpose switch S0 is turned ON for a predetermined time period from a commencement of the mode transition. Since the bias circuit 200 is connected to the MR head 100 via the switches S1 and S2, the bias voltage “VMR” starts to be applied between the MR head-sided positive polarity terminal “Vmp” and the MR head-sided negative polarity terminal “Vmn” of the MR head 100. At this time, when the shortcircuit-purpose switch S0 is turned ON, it may be seen that the DC cut capacitors C0 and C1 constitute a load within a series loop, as viewed from the bias circuit 200. As a consequence, the bias circuit 200 applies a voltage to a resistance component of the MR head 100, and also, charges the DC cut capacitors C0 and C1 within the same predetermined time period. In this case, a terminal response of the MR head 100 represents a first order rising response of a CR time constant. The CR time constant is determined by a series-combined capacitance of the DC cut capacitors C0 and C1, and a series-combined resistance made of a resistance component of the MR head 100 and an ON-resistance of the shortcircuit-purpose switch S0. The charging operations of the DC cut capacitors C0 and C1 are finally accomplished at the substantially same time when the application of the bias voltage to the MR head 100 is accomplished.

In accordance with the first embodiment, although the terminal response of the MR head 100 becomes slower than that of the conventional structure, the DC cut capacitors C0 and C1 can be charged by the first order stable response. Also, although the response time required for the charging operation depends upon the resistance value of the MR head 100, the ON resistance value of the shortcircuit-purpose switch S0, and the capacitance values of the DC cut capacitors C0 and C1, this response time may be designed as a response shorter than, or equal to several tens of nanoseconds. For instance, assuming now that the capacitance values of the DC cut capacitors C0 and C1=100 pF; the resistance value of the MR head 100=50 ohms; and the ON resistance value of the shortcircuit-purpose switch S0=100 ohms, a CR time constant “τ” is calculated as follows:
τ=(50 ohms+100 ohms)×(100 pF/2)=7.5 nanoseconds.
Accordingly, 3τ, i.e., the period of time required for making the amount of target charging value 95% during a primary response becomes 22.5 nanoseconds. Moreover, the amplification factor of the conductor amplifier 400 is not increased higher than, or equal to the amplification factor during the normal operation, and the amplification factor is continuously substantially constant, namely, “gm.” Such a possibility that the stability of the negative feedback loop containing the conductor amplifier 400 is deteriorated can be reduced.

### Embodiment 2

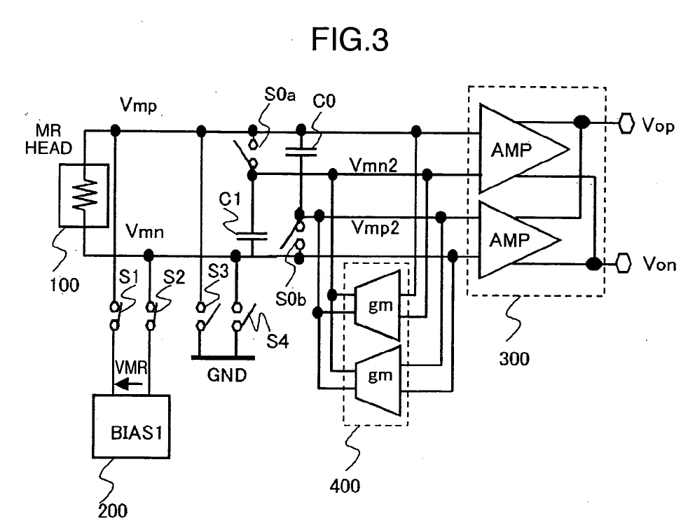

FIG. 3 shows a second embodiment of a magnetic disk apparatus-purpose reproducing circuit to which the present invention is applied. The above-described reproducing circuit is arranged by containing a bias circuit 200, an amplifier 300, DC cut capacitors C0 and C1, a conductor amplifier 400, shortcircuit-purpose switches “S0a” and “S0b”, and also, various sorts of selecting switches S1 to S4. The bias circuit 200 applies a bias voltage (VMR) to an MR head 100. The amplifier 300 amplifies an output from the MR head 100. The DC cut capacitors C0 and C1 cut a DC component of the output of the MR head 100. The conductor amplifier 400 is utilized for applying an input bias of the amplifier 300. The shortcircuit-purpose switches “S0a” and “S0b” are employed so as to charge the DC cut capacitors C0 and C1.

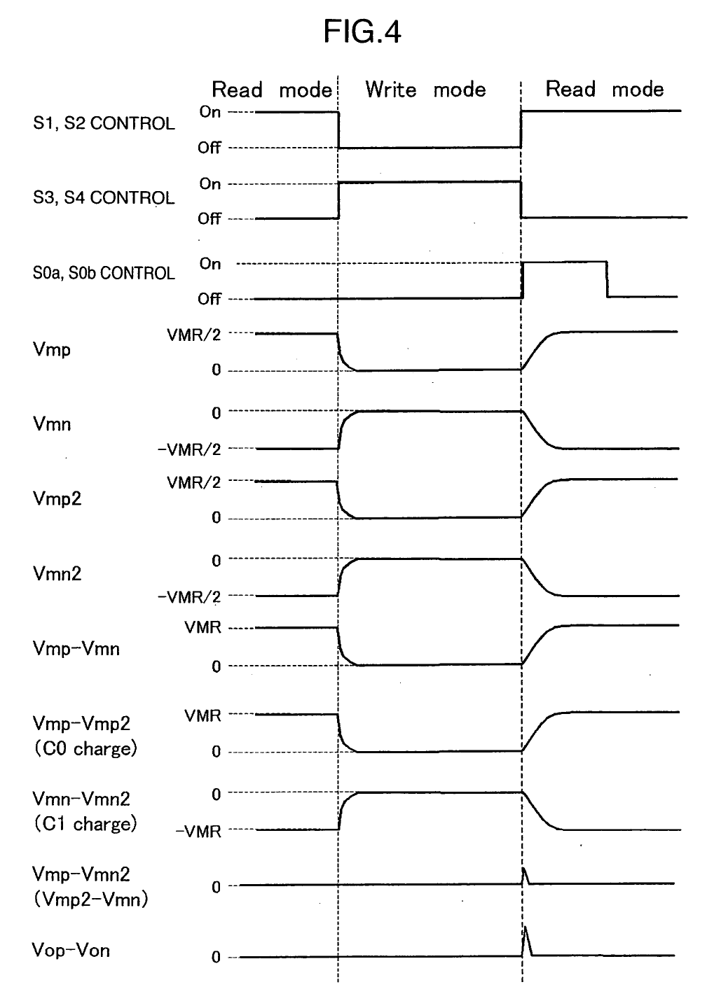

This second embodiment corresponds to such a case that an amplifier having a parallel double structure (dual structure) is employed as the amplifier 300 which amplifies an output from the MR head 100. In this drawing, symbol “Vmp” shows an MR head-sided positive polarity terminal (first differential input positive polarity terminal); symbol “Vmn” indicates an MR head-sided negative polarity terminal (first differential input negative polarity terminal); symbol “Vmp2” represents a second differential input positive polarity terminal; symbol “Vmn2” denotes a second differential input negative terminal; symbol “Vop” shows a differential output positive polarity terminal; symbol “Von” represents a differential output negative polarity terminal; and symbol “VMR” indicates an MR head bias voltage. In this case, a potential of the MR head-sided positive polarity terminal “Vmp” is equal to a potential of the first differential input positive polarity terminal, and also, a potential of the MR head-sided negative polarity terminal “Vmp2” is equal to a potential of the first differential input negative polarity terminal. The second differential input positive polarity terminal “Vmp2” is separated from the MR head-sided positive polarity terminal “Vmp” by the DC cut capacitor C0 in a DC manner, and also the second differential input negative polarity terminal “Vmn2” is separated from the MR head-sided negative polarity terminal “Vmn” by the DC cut capacitor C1 in a DC manner. Also, the first differential input positive polarity terminal “Vmp” and the second differential input negative polarity terminal “Vmn2” are connected to each other via the shortcircuit-purpose switch “S0a”, whereas also, the second differential input positive polarity terminal “Vmp2” and the first differential input negative polarity terminal “Vmn” are connected to each other via the shortcircuit-purpose switch “S0b.”FIG. 4 represents potential responses as to control signals and input/output terminals when a mode transition occurs from a write mode to a read mode of the circuit of FIG. 3. As represented in FIG. 4, when a mode transition from a write mode to a read mode occurs, the switches S1 and S2 which are connected to the MR head 100 are turned ON, whereas the switches S3 and S4 which are connected to the MR head 100 are turned OFF, and also, the shortcircuit-purpose switches S0a and S0b are turned ON for a predetermined time period from a commencement of the mode transition. Since the bias circuit 200 is connected to the MR head 100 via the switches S1 and S2, the bias voltage “VMR” starts to be applied between the MR head-sided positive polarity terminal “Vmp” and the MR head-sided negative polarity terminal “Vmn” of the MR head 100. At this time, when the shortcircuit-purpose switch S0a and S0b are turned ON, it may be seen that the DC cut capacitors C0 and C1 constitute a load within a series loop, as viewed from the bias circuit 200. As a consequence, the bias circuit 200 applies a voltage to a resistance component of the MR head 100, and also, charges the DC cut capacitors C0 and C1 within the same predetermined time period. In this case, a terminal response of the MR head 100 represents a first order rising response of a CR time constant. The CR time constant is determined by a parallel-combined capacitance of the DC cut capacitors C0 and C1, and a series-combined resistance which is defined by both a parallel-combined resistance between the resistance component of the MR head 100 and an ON resistance of the shortcircuit-purpose switch S0a, and another parallel-combined resistance between the resistance component of the MR head 100 and an ON resistance of the shortcircuit-purpose switch S0b. The charging operations of the DC cut capacitors C0 and C1 are finally accomplished at the substantially same time when the application of the bias voltage to the MR head 100 is accomplished.

In accordance with the second embodiment, although the terminal response of the MR head 100 becomes slower than that of the conventional structure, the DC cut capacitors C0 and C1 can be charged by the first order stable response. Also, although the response time required for the charging operation depends upon the resistance value of the MR head 100, the ON resistance values of the shortcircuit-purpose switches S0a and S0b, and the capacitance values of the DC cut capacitors C0 and C1, this response time may be designed as a response shorter than, or equal to several tens of nanoseconds, which is similar to the first embodiment. Moreover, the amplification factor of the conductor amplifier 400 is not increased higher than, or equal to the amplification factor during the normal operation, and the amplification factor is continuously substantially constant, namely, “gm.” Such a possibility that the stability of the negative feedback loop containing the conductor amplifier 400 is deteriorated can be reduced. Also, since the amplifier having the parallel dual structure is employed as the amplifier 300, there is an effect that the capacitance required for the DC cut capacitors C0 and C1 can be reduced by approximately ¼.

### Embodiment 3

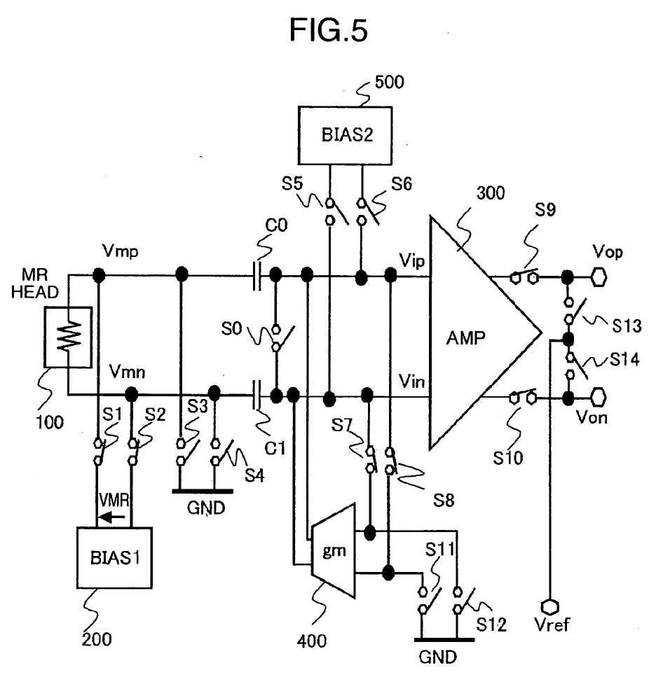

FIG. 5 shows a third embodiment of a magnetic disk apparatus-purpose reproducing circuit to which the present invention is applied. The above-described reproducing circuit is arranged by containing a first bias circuit 200, an amplifier 300, DC cut capacitors C0 and C1, a conductor amplifier 400, a second bias circuit 500, a shortcircuit-purpose switch S0, and various sorts of selecting switches S1 to S14. The first bias circuit 200 applies a bias voltage (VMR) to an MR head 100. The amplifier 300 amplifies an output from the MR head 100. The DC cut capacitors C0 and C1 cut a DC component of the output of the MR head 100. The conductor amplifier 400 is utilized for applying an input bias of the amplifier 300. The second bias circuit 500 produces bias voltages which are equivalent to charging potentials of the DC cut capacitors C0 and C1 so as to hold electric charges of the DC cut capacitors C0 and C1. The shortcircuit-purpose switch S0 is employed so as to charge the DC cut capacitors C0 and C1.

In this drawing, symbol “Vmp” shows an MR head-sided positive polarity terminal; symbol “Vmn” indicates an MR head-sided negative polarity terminal; symbol “Vip” represents a differential input positive polarity terminal; symbol “Vin” denotes a differential input negative terminal; and symbol “VMR” represents a bias voltage of the MR head 100. This arrangement of the reproducing circuit of the third embodiment owns the below-mentioned different points from that of the first embodiment. That is, the second bias circuit 500 is further provided in addition to the first bias circuit 200; the switches S7 to S8 and S11 to S12 are provided in order to hold an input of the conductor amplifier 400 to the ground potential “GND”; and the switches S9 to S10 and S13 to S14 are provided in order that both a differential output positive polarity terminal “Vop” and a differential output negative polarity terminal “Von” of the amplifier 300 are held at a predetermined common reference voltage “Vref.”

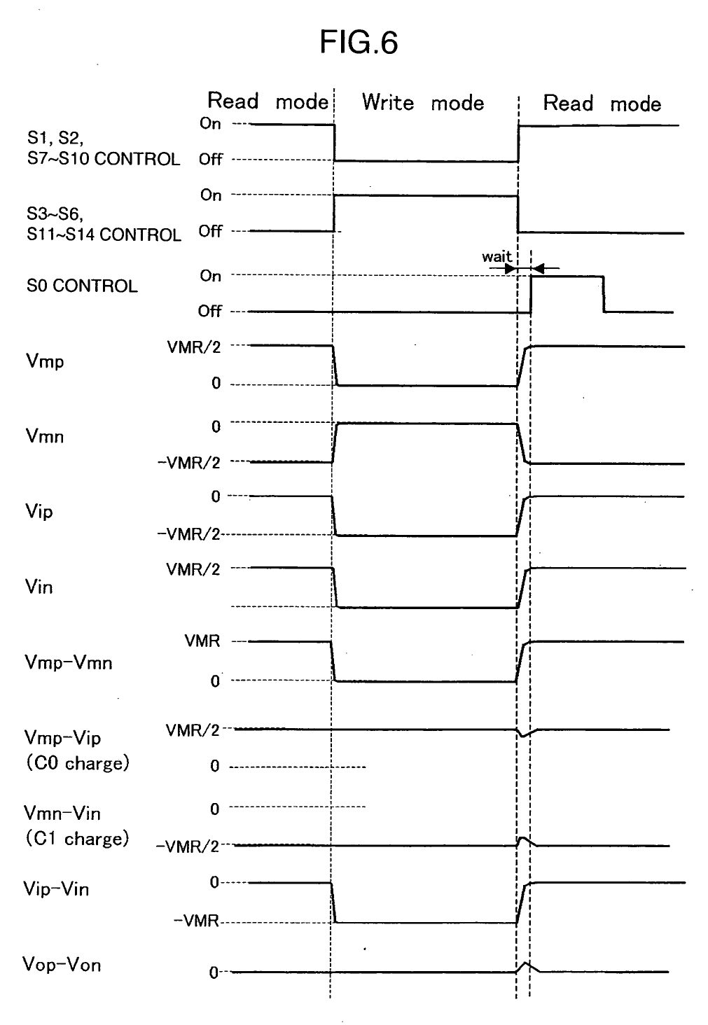

FIG. 6 represents potential responses as to control signals and input/output terminals when a mode transition from a write mode to a read mode occurs. This third embodiment owns the following different point from the first embodiment. That is, a mechanism for holding electric charge information of the DC cut capacitors C0 and C1 during a write time period is further provided. In this third embodiment, as indicated in FIG. 6, during the write time period, while the switches S1 and S2 have been turned OFF, and the switches S3 and S4 have been turned ON, which are connected to the MR head 100, a potential across both input terminals of the MR head 100 becomes zero. At this time, since the switches S5 and S6 connected to the input terminal of the amplifier 300 are turned ON, and the output potential of the second bias circuit 500 is applied in order that the electric charges of the DC cut capacitors C0 and C1 are not discharged, the electric charges of the DC cut capacitors C0 and C1 are held. It should be understood that since the switches S7 to S10 are turned OFF and the switches S11 to S14 are turned ON at this time, the input of the conductor amplifier 400 is held at the ground potential GND and also the differential output terminals “Vop” and “Von” of the amplifier 300 are held at a predetermined common reference potential “Vref”, and also, such an adverse influence caused by that the electric charges of the DC cut capacitors C0 and C1 are held during the write time period is not given to the outputs of the conductor amplifier 4.00 and of the amplifier 300.

When a mode transition from a write mode to a read mode occurs, the switches S1 and S2 which are connected to the MR head 100 are turned ON, whereas the switches S3 to S6 are turned OFF, and the switches S7 to S10 are turned ON, which are connected to the MR head 100, and also, the switches S11 to S14 are turned OFF, which are connected to the MR head 100. It should also be noted that timing for turning ON the shortcircuit-purpose switch S0 is delayed by a time “wait”, as compared with the turn-ON timing of the first embodiment, in order that the electric charges held in the DC cut capacitors C0 and C1 are not passed therethrough until the potential of the MR head 100 rises. In other words, at a time instant delayed by the time “wait” from a commencement of the mode transition, the shortcircuit-purpose switch S0 is controlled to be changed from the OFF state to the ON state, and the ON state of this switch S0 is controlled to be maintained for a predetermined time period from the first-mentioned time instant. Since the first bias circuit 200 is connected to the MR head 100 via the switches S1 and S2, the bias voltage “VMR” starts to be applied between the MR head-sided positive polarity terminal “Vmp” and the MR head-sided negative polarity terminal “Vmn” of the MR head 100. At this time, when the shortcircuit-purpose switch S0 is turned ON after the time “wait” has elapsed, it may be seen that the DC cut capacitors C0 and C1 constitute a load within a series loop, as viewed from the bias circuit 200. As a consequence, the first bias circuit 200 applies a voltage to a resistance component of the MR head 100, and also, charges the DC cut capacitors C0 and C1 within the same predetermined time period. In this case, a terminal response of the MR head 100 represents a first order rising response of a CR time constant. The CR time constant is determined by a series-combined capacitance of the DC cut capacitors C0 and C1, and a series-combined resistance made of a resistance component of the MR head 100 and an ON-resistance of the shortcircuit switch S0. The charging operations of the DC cut capacitors C0 and C1 are finally accomplished at the substantially same time when the application of the bias voltage to the MR head 100 is accomplished.

Similar to the first embodiment, in accordance with the third embodiment, the DC cut capacitors C0 and C1 can be charged by the first order stable response. Also, although the response time required for the charging operation depends upon the resistance value of the MR head 100, the ON resistance value of the shortcircuit switch S0, and the capacitance values of the DC cut capacitors C0 and C1, this response time may be designed as a response shorter than, or equal to several tens of nanoseconds, which is similar to the first embodiment. Moreover, the amplification factor of the conductor amplifier 400 is not increased higher than, or equal to the amplification factor during the normal operation, and the amplification factor is continuously substantially constant, namely, “gm.” Such a possibility that the stability of the negative feedback loop containing the conductor amplifier 400 is deteriorated can be reduced. As an effect different from that of the first embodiment, the below-mentioned effect may be achieved. In other words, when the mode transition from the write mode to the read mode occurs, since the shortcircuit-purpose switch S0 has been turned OFF, the bias voltage of the input terminals of the MR head 100 rises at a high speed. Thereafter, the shortcircuit-purpose switch S0 is turned ON so as to charge the DC cut capacitors C0 and C1. In this charging operation, since the charging operation is commenced from such a condition that the substantially necessary amounts of electric charges have already been charged in these DC cut capacitors C0 and C1, time required for this charging operation can be shortened.

### Embodiment 4

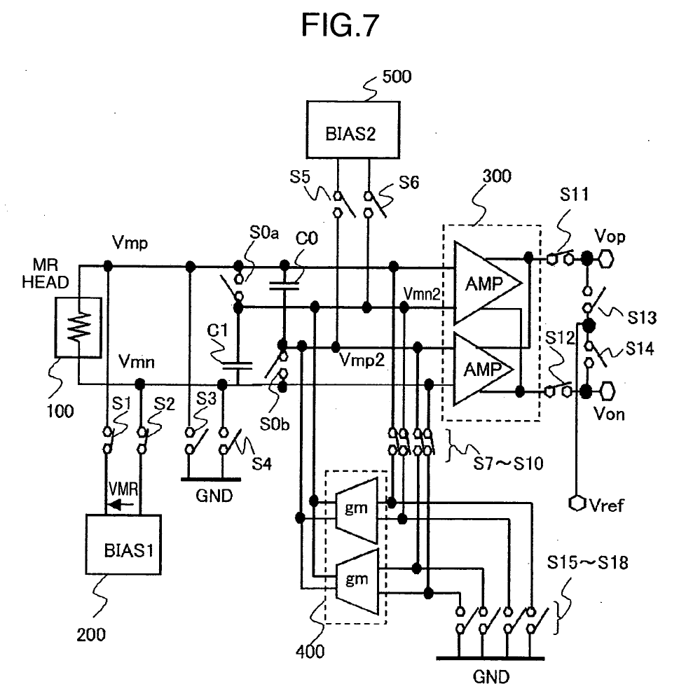

FIG. 7 shows a fourth embodiment of a magnetic disk apparatus-purpose reproducing circuit to which the present invention is applied. The above-described reproducing circuit is arranged by containing a first bias circuit 200, an amplifier 300, DC cut capacitors C0 and C1, a conductor amplifier 400, a second bias circuit 500, shortcircuit-purpose switches S0a, S0b, and various sorts of selecting switches S1 to S18. The first bias circuit 200 applies a bias voltage (VMR) to an MR head 100. The amplifier 300 amplifies an output from the MR head 100. The DC cut capacitors C0 and C1 cut a DC component of the output of the MR head 100. The conductor amplifier 400 is utilized for applying an input bias of the amplifier 300. The second bias circuit 500 produces bias voltages which are equivalent to charging potentials of the DC cut capacitors C0 and C1 so as to hold electric charges of the DC cut capacitors C0 and C1. The shortcircuit-purpose switches S0a and S0b are employed so as to charge the DC cut capacitors C0 and C1.

This fourth embodiment corresponds to such a case that an amplifier having a parallel double structure (dual structure) is employed as the amplifier 300 which amplifies an output from the MR head 100. In this drawing, symbol “Vmp” shows an MR head-sided positive polarity terminal (first differential input positive polarity terminal); symbol “Vmn” indicates an MR head-sided negative polarity terminal (first differential input negative polarity terminal); symbol “Vmp2” represents a second differential input positive polarity terminal; symbol “Vmn2” denotes a second differential input negative terminal; symbol “Vop” shows a differential output positive polarity terminal; symbol “Von” represents a differential output negative polarity terminal; and symbol “VMR” indicates an MR head bias voltage. In this case, a potential of the MR head-sided positive polarity terminal “Vmp” is equal to a potential of the first differential input positive polarity terminal, and also, a potential of the MR head-sided negative polarity terminal “Vmp2” is equal to a potential of the first differential input negative polarity terminal. The second differential input positive polarity terminal “Vmp2” is separated from the MR head-sided positive polarity terminal “Vmp” by the DC cut capacitor C0 in a DC manner, and also the second differential input negative polarity terminal “Vmn2” is separated from the MR head-sided negative polarity terminal “Vmn” by the DC cut capacitor C1 in a DC manner. Also, the first differential input positive polarity terminal “Vmp” and the second differential input negative polarity terminal “Vmn2” are connected to each other via the shortcircuit-purpose switch “S0a”, whereas also, the second differential input positive polarity terminal “Vmp2” and the first differential input negative polarity terminal “Vmn” are connected to each other via the shortcircuit-purpose switch “S0b.” This arrangement of the reproducing circuit of the fourth embodiment owns the below-mentioned different points from that of the second embodiment. That is, the second bias circuit 500 is further provided in addition to the first bias circuit 200; the switches S7 to S10 and S15 to S18 are provided in order to hold an input of the conductor amplifier 400 to the ground potential “GND”; and the switches S11 to S14 are provided in order that both a differential output positive polarity terminal “Vop” and a differential output negative polarity terminal “Von” of the amplifier 300 are held at a predetermined common reference voltage “Vref.”

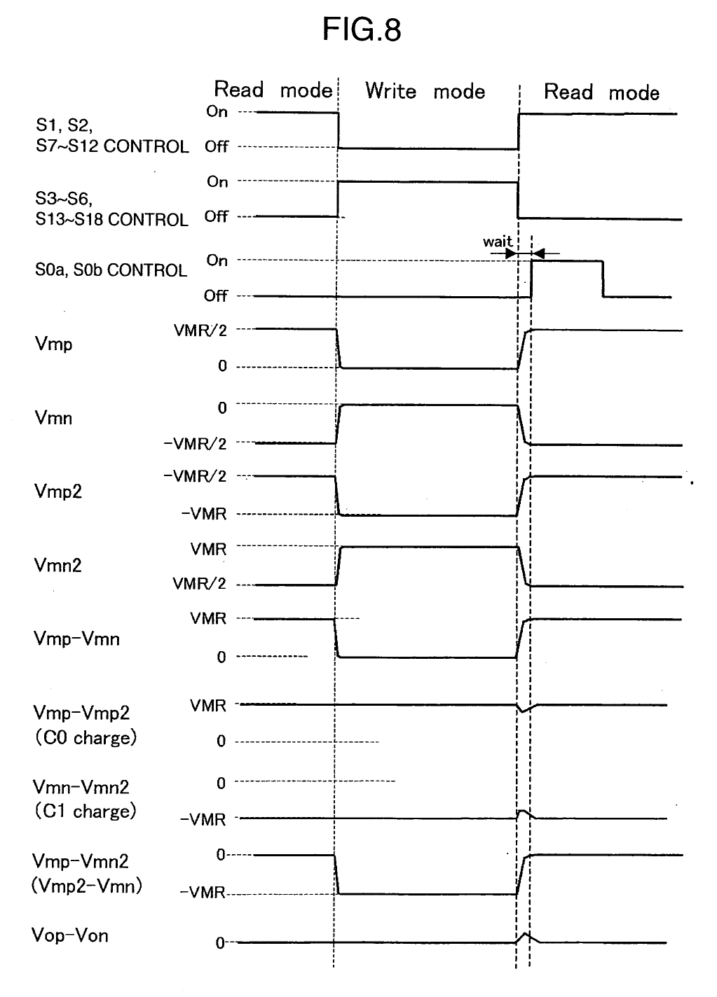

FIG. 8 represents potential responses as to control signals and input/output terminals when a mode transition from a write mode to a read mode occurs in the circuit of FIG. 7. This fourth embodiment owns the following different point from the second embodiment. That is, a mechanism for holding electric charge information of the DC cut capacitors C0 and C1 during a write time period is further provided. In this fourth embodiment, as indicated in FIG. 8, during the write time period, while the switches S1 and S2 have been turned OFF, and the switches S3 and S4 have been turned ON, which are connected to the MR head 100, a potential across both input terminals of the MR head 100 becomes zero. At this time, since the switches S5 and S6 connected to the input terminal of the amplifier 300 are turned ON, and the output potential of the second bias circuit 500 is applied in order that the electric charges of the DC cut capacitors C0 and C1 are not discharged, the electric charges of the DC cut capacitors C0 and C1 are held. It should be understood that since the switches S7 to S12 are turned OFF and the switches S13 to S18 are turned ON at this time, the input of the conductor amplifier 400 is held at the ground potential GND, and also, such an adverse influence caused by that the electric charges of the DC cut capacitors C0 and C1 are held during the write time period is not given to the outputs of the conductor amplifier 400 and of the amplifier 300.

When a mode transition from a write mode to a read mode occurs, the switches S1 and S2 which are connected to the MR head 100 are turned ON, whereas the switches S3 to S6 are turned OFF which are connected to the MR head 100. It should also be noted that timing for turning ON the shortcircuit-purpose switches S0a and S0b is delayed by a time “wait”, as compared with the turn-ON timing of the second embodiment, in order that the electric charges held in the DC cut capacitors C0 and C1 are not passed therethrough until the potential of the MR head 100 rises. In other words, at a time instant delayed by the time “wait” from a commencement of the mode transition, the shortcircuit-purpose switches S0a and S0b are controlled to be changed from the OFF state to the ON state, and the ON states of these switches S01 and S02 are controlled to be maintained for a predetermined time period from the first-mentioned time instant. Since the first bias circuit 200 is connected to the MR head 100 via the switches S1 and S2, the bias voltage “VMR” starts to be applied between the MR head-sided positive polarity terminal “Vmp” and the MR head-sided negative polarity terminal “Vmn” of the MR head 100. At this time, when the shortcircuit-purpose switches S01 and S02 are turned ON after the time “wait” has elapsed, it may be seen that the DC cut capacitors C0 and C1 constitute a load within a series loop, as viewed from the bias circuit 200. As a consequence, the first bias circuit 200 applies a voltage to a resistance component of the MR head 100, and also, charges the DC cut capacitors C0 and C1 within the same predetermined time period. In this case, a terminal response of the MR head 100 represents a first order rising response of a CR time constant. The CR time constant is determined by a parallel-combined capacitance of the DC cut capacitors C0 and C1, and a series-combined resistance which is defined by both a parallel-combined resistance between the resistance component of the MR head 100 and an ON resistance of the shortcircuit-purpose switch S0a, and another parallel-combined resistance between the resistance component of the MR head 100 and an ON resistance of the shortcircuit-purpose switch S0b. The charging operations of the DC cut capacitors C0 and C1 are finally accomplished at the substantially same time when the application of the bias voltage to the MR head 100 is accomplished.

Similar to the second embodiment, in accordance with the fourth embodiment, the DC cut capacitors C0 and C1 can be charged by the first order stable response. Also, although the response time required for the charging operation depends upon the resistance value of the MR head 100, the ON resistance value of the shortcircuit switch S0, and the capacitance values of the DC cut capacitors C0 and C1, this response time may be designed as a response shorter than, or equal to several tens of nanoseconds, which is similar to the second embodiment. Moreover, the amplification factor of the conductor amplifier 400 is not increased higher than, or equal to the amplification factor during the normal operation, and the amplification factor is continuously substantially constant, namely, “gm.” Such a possibility that the stability of the negative feedback loop containing the conductor amplifier 400 is deteriorated can be reduced. As an effect different from that of the second embodiment, the below-mentioned effect may be achieved. In other words, when the mode transition from the write mode to the read mode occurs, since the shortcircuit-purpose switch S0 has been turned OFF, the bias voltage of the input terminals of the MR head 100 rises at a high speed. Thereafter, the shortcircuit-purpose switches S0a and S0b are turned ON so as to charge the DC cut capacitors C0 and C1. In this charging operation, since the charging operation is commenced from such a condition that the substantially necessary amounts of electric charges have already been charged in these DC cut capacitors C0 and C1, time required for this charging operation can be shortened. Also, since the amplifier having the parallel dual structure is employed as the amplifier 300, there is an effect that the capacitance required for the DC cut capacitors C0 and C1 can be reduced by approximately ¼.

### Embodiment 5

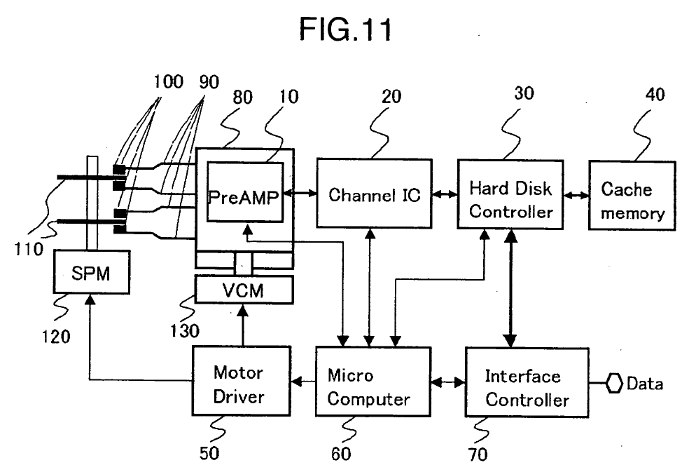

FIG. 11 shows one embodiment of a magnetic disk apparatus (hard disk apparatus) as a block diagram, which constitutes one example of a medium recording system to which the present invention is advantageously applied.

The magnetic disk apparatus of this embodiment 5 is arranged by employing at least an MR head 100 functioning as a reading head, and the reproducing circuit shown in any one of the above-explained embodiments 1 to 4. Preferably, as indicated in FIG. 11, the magnetic disk apparatus is arranged by employing a recording medium 110 such as a magnetic disk, a spindle motor 120 for rotating the magnetic disk 110, a suspension arm 90, a carriage 80 for holding the suspension arm 90 on a rotation shaft, an actuator-purpose voice coil motor 130 for transporting the carriage 80, a motor driver 50 for driving both the spindle motor 120 and the voice coil motor 130, a preamplifier 10, a signal processing circuit (channel IC) 20, a hard disk controller 30, an interface controller 70, a microcomputer 60 for controlling the entire system of the magnetic disk apparatus in an unified manner, and also, a buffer-purpose cache memory 40 for temporarily storing thereinto data. The suspension arm 90 owns a magnetic head at a tip portion thereof, while the magnetic head is constituted by containing a reading head (MR head 100) and a writing head. The preamplifier 10 amplifies a signal detected via the MR head 100 which constitutes the magnetic head, and also, drives a coil of the writing head which constitutes the magnetic head. The signal processing circuit 20 performs a signal processing operation such as a waveform shaping operation by considering a magnetic recording characteristic. The hard disk controller 30 performs an error correction-purpose coding process operation with respect to data read out from the channel IC 20 and data written from a host.

Although it is preferable to arrange the preamplifier 10 on a side plane of the carriage 90, the present invention is not limited to the above-described arranging position. Also, the preamplifier 10 is manufactured in such a manner that this preamplifier is integrated on a single semiconductor substrate made of, for example, monocrystal silicon in one chip by using known integrated circuit techniques for bipolar transistors, CMOS (complementary type MOS) transistors, and the like. Then, the reproducing circuit (namely, circuit elements for constructing circuit block of each embodiment except for MR head) of the present invention is integrated in one chip of a monolithic IC in combination with the recording circuit. The signal processing circuit (channel IC) 20 is such a circuit which inputs an analog signal which is produced/outputted by the reproducing circuit of the preamplifier 10 from magnetic information recorded on a magnetic recording medium (hard disk), and converts the input analog signal into a digital signal made of bit information, and then, outputs the converted digital signal to the hard disk controller 30. It is preferable to construct the signal processing circuit 20 as another signal semiconductor integrated circuit which is independent from that of the preamplifier 10.

A hard disk control system is arranged by the preamplifier 10, the channel IC 20, the hard disk controller 30, the cache memory 40, the motor driver 50, the microcomputer 60, and the interface controller 70. A magnetic disk apparatus (hard disk apparatus) is arranged as one example of the medium recording/reproducing system by this hard disk control system, the carriage 80, the suspension 90, the magnetic disk 110, the magnetic head 100, the spindle motor 120, and the voice coil motor 130.

In accordance with this embodiment, as previously explained, the response characteristic of the charging operation can be stabilized without deteriorating the charging speed by the reproducing circuit of the embodiment 1 to 4. As a result, a throughput of the entire magnetic disk apparatus can be improved, and the data processing amount per unit time can be increased. As a consequence, the magnetic disk apparatus can also be applied to such a system capable of reading information from a recording medium where information has been recorded in a high density.

It should be further understood by those skilled in the art that although the foregoing description has been made on embodiments of the invention, the invention is not limited thereto and various changes and modifications may be made without departing from the spirit of the invention and the scope of the appended claims.

1. A reproducing circuit comprising:
a first bias circuit connected to differential output terminals of a magneto-resistive head for generating a differential output voltage corresponding to information read out from a magnetic recording medium between said differential output terminals, for applying a bias voltage between a positive polarity and a negative polarity of said differential output terminals;
one pair of DC cut capacitors connected to said differential output terminals of said magneto-resistive head, for cutting off a DC component of an output of said magneto-resistive head;
an output amplifier which has differential input terminals constructed of a positive polarity and a negative polarity, is connected via said one pair of DC cut capacitors to said differential output terminals of said magneto-resistive head by way of said differential input terminals, and amplifies the output of said magneto-resistive head, the DC component of which has been cut off;
a conductor amplifier which has differential input terminals and differential output terminals, which are constituted by positive polarities and negative polarities, and is connected to said differential input terminals of said output amplifier in a negative feedback manner so as to apply an input bias of said output amplifier; and
a shortcircuit switch connected between said positive polarity and said negative polarity of said differential input terminals of said output amplifier.

2. A reproducing circuit as claimed in claim 1 wherein:
said first bias circuit is connected via one pair of first switches to said differential output terminals of said magneto-resistive head; and
potentials of said differential output terminals are held at the ground potential for a time period during which said one pair of first switches are under OFF states.

3. A reproducing circuit as claimed in claim 2 wherein:
an operating state of said shortcircuit switch is transferred from an OFF state to an ON state when operating states of said one pair of first switches are transferred from OFF states to ON states, and said shortcircuit switch holds said ON state thereof for a predetermined time period from said transition time instant, and thereafter is transferred to an OFF state.

4. A reproducing circuit as claimed in claim 1 wherein:
said output amplifier is constituted by containing two sets of unit output amplifiers which commonly own respective differential output terminals;
said positive polarity of said differential input terminals of said output amplifier is constituted by containing a first differential input positive polarity terminal corresponding to a positive polarity of one differential input terminal of said two unit output amplifiers, and a second differential input positive polarity terminal corresponding to a positive polarity of the other differential input terminal of said two unit output amplifiers;
said negative polarity of said differential input terminals of said output amplifier is constituted by containing a first differential input negative polarity terminal corresponding to a negative polarity of the other differential input terminal of said two unit output amplifiers, and a second differential input negative polarity terminal corresponding to a negative polarity of one differential input terminal of said two unit output amplifiers;
both said positive polarity terminal of said differential output terminals of said magneto-resistive head and said first differential input positive polarity terminal are equi-potentials to each other;
both said negative polarity terminal of said differential output terminals of said magneto-resistive head and said first differential input negative polarity terminal are equi-potentials to each other;
said second differential input positive polarity terminal is separated from said positive polarity terminal of said differential output terminals of said magneto-resistive head in a DC manner by one capacitor of said one pair of DC cut capacitors;
said second differential input negative polarity terminal is separated from said negative polarity terminal of said differential output terminals of said magneto-resistive head in a DC manner by the other capacitor of said one pair of DC cut capacitors; and
said shortcircuit switch is constituted by containing a first shortcircuit switch connected between said first differential input positive polarity terminal and said second differential input negative polarity terminal; and a second shortcircuit switch connected between said second differential input positive polarity terminal and said first differential input negative polarity terminal.

5. A reproducing circuit as claimed in claim 4 wherein:
said conductor amplifier is constituted by containing two sets of unit conductor amplifiers whose amplification factors are equal to each other;
said positive polarity of said differential input terminals of said conductor amplifier is constituted by containing a first differential input positive polarity terminal corresponding to a positive polarity of one differential input terminal of said two unit conductor amplifiers, and a second differential input positive polarity terminal corresponding to a positive polarity of the other differential input terminal of said two unit conductor amplifiers;
said negative polarity of said differential input terminals of said conductor amplifier is constituted by containing a first differential input negative polarity terminal corresponding to a negative polarity of the other differential input terminal of said two unit conductor amplifiers, and a second differential input negative polarity terminal corresponding to a negative polarity of one differential input terminal of said two unit conductor amplifiers;
said first and second differential input positive terminals of said unit conductor amplifier are connected to said first and second differential input positive terminals of said output amplifier respectively;
said first and second differential input negative terminals of said unit conductor amplifier are connected to said first and second differential input negative terminals of said output amplifier respectively; and
said differential output terminals of said conductor amplifier are commonly owned between said two unit conductor amplifiers, and are connected to said second differential input terminals of said output amplifier.

6. A reproducing circuit as claimed in claim 5 wherein:
said first bias circuit is connected via one pair of first switches to said differential output terminals of said magneto-resistive head; and
potentials of said differential output terminals are held at the ground potential for a time period during which said one pair of first switches are under OFF states.

7. A reproducing circuit as claimed in claim 6 wherein:
operating states of said first and second shortcircuit switches are transferred from OFF states to ON states when the operating states of said one pair of first switches are transferred from OFF states to ON states, and said first and second shortcircuit switches hold said ON states thereof for a predetermined time period from said transition time instant, and thereafter are transferred to OFF states.

8. A reproducing circuit as claimed in claim 1, further comprising:
a second bias circuit for generating a bias voltage equivalent to a charging potential of said one pair of DC cut capacitors and for applying said generated bias voltage to said differential input terminals of said output amplifier.

9. A reproducing circuit as claimed in claim 8 wherein:
said first bias circuit is connected via one pair of first switches to said differential output terminals of said magneto-resistive head;
said second bias circuit is connected via one pair of second switches to said differential input terminals of said output amplifier; and
in a time period during which one pair of said first switches are under OFF states, the potential of said differential output terminal is held at the ground potential, and while ON states of one pair of said second switches are held, said bias voltage generated by said second bias circuit is applied to said differential input terminals.

10. A reproducing circuit as claimed in claim 9 wherein:
the operating state of said shortcircuit switch is transferred from an OFF state to an ON state at a time instant delayed by a predetermined delay time from such a time instant when the operating states of said one pair of first switches are transferred from the OFF states to the ON states, and also, the operating states of said one pair of second switches are transferred from the ON states to the OFF states; and the ON state of said shortcircuit switch is held for a predetermined time period after said transition time instant, and thereafter, said ON state thereof is transferred to the OFF state.

11. A reproducing circuit as claimed in claim 4, further comprising:
a second bias circuit for generating a bias voltage equivalent to a charging potential of said one pair of DC cut capacitors and for applying said generated bias voltage to said second differential input terminals of said output amplifier.

12. A reproducing circuit as claimed in claim 11 wherein:
said first bias circuit is connected via one pair of first switches to said differential output terminals of said magneto-resistive head;
said second bias circuit is connected via one pair of second switches to said second differential input terminals of said output amplifier; and
in a time period during which one pair of said first switches are under OFF states, the potential of said differential output terminals is held at the ground potential, and while ON states of one pair of said second switches are held, said bias voltage generated by said second bias circuit is applied to said second differential input terminals.

13. A reproducing circuit as claimed in claim 12 wherein:
the operating states of said first and second shortcircuit switches are transferred from OFF states to ON states at a time instant delayed by a predetermined delay time from such a time instant when the operating states of said one pair of first switches are transferred from the OFF states to the ON states, and also, the operating states of said one pair of second switches are transferred from the ON states to the OFF states; and the ON states of said first and second shortcircuit switches are held for a predetermined time period after said transition time instant, and thereafter, said ON states thereof are transferred to the OFF states.

14. A reproducing circuit as claimed in claim 1 wherein:
said first bias circuit, said DC cut capacitors, said output amplifier, said conductor amplifier, and said shortcircuit switch are integrated on a single semiconductor substrate.

15. A reproducing circuit as claimed in claim 8 wherein:
said first bias circuit, said second bias circuit, said DC cut capacitors, said output amplifier, said conductor amplifier, and said shortcircuit switch are integrated on a single semiconductor substrate.

16. A reproducing circuit which is employed in a magnetic disk apparatus operated in operation modes including a read mode and a write mode, comprising:
a first bias circuit connected to differential output terminals of a magneto-resistive head for generating a differential output voltage corresponding to information read out from a magnetic recording medium between said differential output terminals, for applying a bias voltage between a positive polarity and a negative polarity of said differential output terminals during said read mode;
one pair of DC cut capacitors connected to said differential output terminals of said magneto-resistive head, for cutting off a DC component of an output of said magneto-resistive head;
an output amplifier which has differential input terminals constructed of a positive polarity and a negative polarity, is connected via said one pair of DC cut capacitors to said differential output terminals of said magneto-resistive head by way of said differential input terminals, and amplifies the output of said magneto-resistive head, the DC component of which has been cut off;
a conductor amplifier which has differential input terminals and differential output terminals, which are constituted by positive polarities and negative polarities, and is connected to said differential input terminals of said output amplifier in a negative feedback manner so as to apply an input bias of said output amplifier; and
a shortcircuit switch for shortcircuiting a path between said positive polarity and said negative polarity of said differential input terminals of said output amplifier based upon a transition of said operation modes; and wherein:
an amplification factor of said conductor amplifier is substantially constant irrespective of such a fact that said operation mode of said magnetic disk apparatus corresponds to either said read mode or said write mode.

17. A reproducing circuit as claimed in claim 16 wherein:
for a time period during which said operation mode is said write mode, the potential of said differential output terminals is maintained at the ground potential.

18. A reproducing circuit as claimed in claim 17 wherein:
an operating state of said shortcircuit switch is transferred from an OFF state to an ON state at a time instant when said operation mode starts to be transferred from said write mode to said read mode, and said shortcircuit switch holds the ON state thereof for a predetermined time period from said transition time instant, and before a transition from said read mode to said write mode is commenced, the operating state of the shortcircuit switch is transferred from the ON state to the OFF state.

19. A magnetic disk apparatus operated in operation modes including a read mode and a write mode, and arranged by comprising:
a magneto-resistive head having differential output terminals constructed of a positive polarity and a negative polarity, and generating a differential output voltage corresponding to information read out from a magnetic recording medium during said read mode at this differential output terminal; and
a reproducing circuit for amplifying said differential output voltage outputted to said differential output terminals by said magneto-resistive head to output the amplified differential output voltage to a signal processing circuit; wherein:
said reproducing circuit is comprised of:
a first bias circuit connected to said differential output terminals of said magneto-resistive head, for applying a bias voltage between said positive polarity and said negative polarity of said differential output terminals;
one pair of DC cut capacitors connected to said differential output terminals of said magneto-resistive head, for cutting off a DC component of an output of said magneto-resistive head;
an output amplifier which has differential input terminals constructed of a positive polarity and a negative polarity, is connected via said one pair of DC cut capacitors to said differential output terminals of said magneto-resistive head by way of said differential input terminals, and amplifies the output of said magneto-resistive head, the DC component of which has been cut off;
a conductor amplifier which has differential input terminals and differential output terminals, which are constituted by positive polarities and negative polarities, and is connected to said differential input terminals of said output amplifier in a negative feedback manner so as to apply an input bias of said output amplifier; and
a shortcircuit switch for shortcircuiting a path between said positive polarity and said negative polarity of said differential input terminals of said output amplifier based upon a transition of said operation modes; and wherein:
an amplification factor of said conductor amplifier is substantially constant irrespective of such a fact that said operation mode of said magnetic disk apparatus corresponds to either said read mode or said write mode.

20. A magnetic disk apparatus as claimed in claim 19 wherein:
for a time period during which said operation mode is said write mode, the potential of said differential output terminals is maintained at the ground potential.

21. A magnetic disk apparatus as claimed in claim 20 wherein:
an operating state of said shortcircuit switch is transferred from an OFF state to an ON state at a time instant when said operation mode starts to be transferred from said write mode to said read mode, and said shortcircuit switch holds the ON state thereof for a predetermined time period from said transition time instant, and before a transition from said read mode to said write mode is commenced, the operating state of the shortcircuit switch is transferred from the ON state to the OFF state.
